(19) United States
(12) Patent Application Publication
(10) Pub. No.: US 2009/0024621 A1
(43) Pub. Date: Jan. 22, 2009

(54) METHOD TO SET UP ONLINE BOOK COLLECTIONS AND FACILITATE SOCIAL INTERACTIONS ON BOOKS

(75) Inventors: David Anthony Burgess, Menlo Park, CA (US); Shyam Kapur, Sunnyvale, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/778,597

(22) Filed: Jul. 16, 2007

(51) Int. Cl. G06F 17/30

(52) U.S. Cl. 707/6; 707/E17.014

(57) ABSTRACT

A computer-implemented method for recommending books is provided, which comprises the following: receiving data representing at least one image of a collection of books; automatically determining at least one piece of standard information about the collection of books by processing the image data; and recommending at least one book that is not included in the collection of books to a person associated with the collection of books based on the collection of books.

### BACKGROUND OF THE INVENTION

1. Field of the Invention

The present invention relates to systems and methods for recommending books to people based on their collections of books and/or facilitating people to engage in online social interactions with regard to their book collections.

2. Background of the Invention

People who love to read often wish to discuss the books they have read or enjoyed with other people, especially with other people who have read the same books and/or who like the same types of books. Sometimes, people join book clubs and/or reading groups so that they may meet other readers with similar interests. The book clubs and/or reading groups provide social settings where friends and like-minded people may meet to discuss the books they have read and/or to receive recommendations on books they may wish to read.

Traditionally, members of book clubs or reading groups meet in person periodically to discuss the books they have read. In this case, the members are limited by their geographical locations—that is, a book club or reading group usually only has members who are located relatively close to the location where the club or group meets. More recently, the advent of web forums and emails has made it possible for book clubs and/or reading groups to exist online. With online book clubs or reading groups, members may be from all over the world, and so a person has a chance to interact and discuss books with a great number of readers from near and far. However, whether with traditional or online book clubs and/or reading groups, the discussions often tend to focus on a few specific literary works at a time, instead of covering all the books the members have read or owned.

Alternatively, people may submit book reviews at various websites, such as http://www.amazon.com or http://www.barnesandnoble.com. The websites may collect reviews from their customers to provide customer ratings on the books. The websites may also recommend books to their customers. However, people may only submit reviews regarding one book at a time and the book recommendations are usually based on past purchases or sales data or a single review regarding a particular book.

Accordingly, what are needed are systems and methods to address the above-identified issues.

### SUMMARY OF THE INVENTION

Broadly speaking, the present invention relates to recommending books to people based on their collections of books and/or facilitating people to engage in online social interactions with regard to their book collections.

In one or more embodiments, a computer-implemented method for recommending books is provided, which comprises the following: receiving data representing at least one image of a collection of books; automatically determining at least one piece of standard information about the collection of books by processing the image data; and recommending at least one book that is not included in the collection of books to a person associated with the collection of books based on the collection of books.

In another embodiment, a computer-implemented method for recommending books is provided, which comprises the following: receiving data representing at least one image of a collection of books; automatically determining at least one piece of standard information about the collection of books by processing the image data; receiving at least one rating for at least one book from the collection of books, wherein each rating is associated with each book respectively; for each book for which a rating is received, aggregating the rating with existing ratings for the book, storing the standard information, the ratings, and the aggregated rating for the book, and publishing the aggregated rating; and recommending at least one book that is not included in the collection of books to a person associated with the collection of books based on the collection of books.

In another embodiment, a computer program product for recommending books is provided, comprising a computer-readable medium having a plurality of computer program instructions stored therein is provided. The plurality of computer program instructures are operable to cause at least one computing device to: receive data representing at least one image of a collection of books; automatically determine at least one piece of standard information about the collection of books by processing the image data; and recommend at least one book that is not included in the collection of books to a person associated with the collection of books based on the collection of books.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart of a method that makes book recommendations to people based on their respective collections of books and/or facilitates people to discuss their collections of books online.

FIG. 2 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

People who love to read often wish to discuss the books they have read or enjoyed with other people, especially with other people who have read the same books or who like the same types of books. They may also appreciate recommendations on books that are suitable or complimentary to their particular literary interests or tastes and/or other characteristics. Systems and methods may be provided to enable people to upload their collections of books onto an Internet-based system or client-based system and optionally provide ratings and/or reviews on these books. Book recommendations may then be tailored and made to each individual based on his or her collection, ratings, reviews and preferences of books. Book recommendations may be further based on other collections of books in the system. In addition, the Internet-based system or client-based system may provide a social forum where people may discuss various books with other people on the system. The system may suggest to each individual other people on the system who have similar collections, ratings, reviews and/or preferences as the individual with whom the individual may, for example, discuss books.

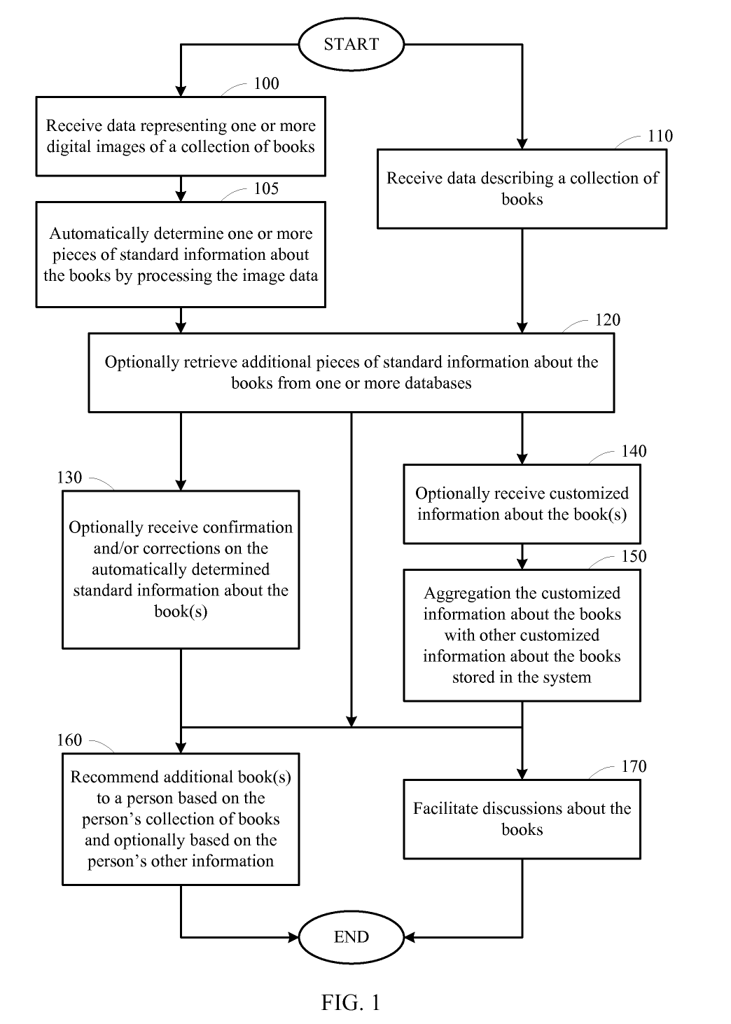

FIG. 1 is a flowchart of a method that makes book recommendations to people based on their respective collections of books and/or facilitates people to discuss their collections of books online. There are various methods for a person to input information about his or her collection of books into a system. In one or more embodiments, at 100, a system receives data representing one or more digital images of a collection of books. Usually, the image data are uploaded onto the system by the owner of the books. Alternatively, it is also possible for another person to upload the image data on behalf of or for the owner.

There are many ways to obtain image(s) of a collection of books. For example, if the books are stored in one or more bookcases or on bookshelves, a person may take photograph(s) of the front of the bookcase(s) where the books are visible. Alternatively, the books may be laid out on some type of surface so that their photograph(s) may be taken. Images may be taken of the outside of the books, such as the front covers, the back covers, and/or the bindings, and it is desirable that information printed on the outside of the books, such as book titles, author names, publisher names, ISBN (International Standard Book Number), etc., are relatively clearly visible in the image(s). Images of the inside of the books may also be used. For example, images of the inside covers, the first few pages of the books, and/or sometimes the last few pages of the books often include information such as book titles, author names, publisher names, publisher addresses, editions, ISBN, etc., and image data of these pages may be uploaded onto the system.

The image(s) may be obtained using digital cameras, mobile telephone cameras, conventional cameras, or scanning devices. Image(s) taken with digital cameras and mobile telephone cameras are stored in digital formats directly, and the digital image data may be downloaded to a computer. Alternatively, the image data may be stored in the digital cameras or mobile telephones. Similarly, images obtained using scanning devices are usually stored in digital formats directly. On the other hand, photograph(s) taken with conventional cameras need to be scanned using a scanner in order to obtain the digital image data. Again, the image data may be saved on a computer and/or be uploaded directly to the system.

Image data may be stored or encoded using various image file formats. For some file formats, the image data may be stored in compressed form; for other file formats, the image data may be stored in uncompress form. For example, GIF (Graphics Interchange Format), JPEG (Joint Photographic Experts Group), TIFF (Tagged Image File Format), and PNG (Portable Network Graphics) are some of the commonly used file formats for storing digital images.

Once the image(s) of the collection of books are obtained, the data representing the image(s) may be uploaded onto an Internet-based system or client-based system either directly from the digital cameras, mobile telephones, or scanning devices, if these devices have Internet access capabilities, or from the computers where the images data are stored. The devices (i.e., digital cameras, mobile telephones, scanner, or computers) may be connected to the system via various types of networks linked to the Internet or the mobile telephone networks. In one or more embodiments, a person first registers with the system to obtain a user account. By registering with the system, a person becomes a user or a customer of the system. Thereafter, the digital image(s) are uploaded into the person's account so that the person may access them in the future.

After the system receives the image data, at 105, the system processes the image data to automatically determine one or more pieces of the standard information about the books. In one or more embodiments, the standard information about a book may include the book's title, author, publisher, publication date, ISBN, edition, binding, and etc.

There are many ways to process image data to obtain specific information captured in the image. For example, optical character recognition (OCR) software may be used to detect and determine characters printed on the books that are captured in the image(s), which may be book titles, author names, or publisher names. If publishers' icons are printed on the books, they may also be used to determine publisher names.

Alternatively, at 110, a person may enter data describing a collection of books into the system directly. For example, the person may simply type in the titles and authors, or the ISBN of the books one by one. Or, the person may use a barcode scanner to scan the barcodes associated with the ISBN of the books into the system.

It is not necessary to obtain all standard information about the books from processing the image data (step 105) or from data directly entered by the person associated with the book collection (step 110). A book may be identified, for example, by its title, ISBN, author, etc. Sometimes, a few pieces of information, such as ISBN or title and author, may uniquely identify a particular book. Once a book is identified, additional information about the book may be obtained from alternative sources. At 120, the system optionally retrieves additional pieces of standard information about the books from one or more databases using the few pieces of information determined by processing the image data.

In one or more embodiments, the system may maintain a database that includes various types of information about published books. Such information may be obtained, for example, directly from the publishers. For each book identified in the image(s), once some pieces of information about that book, such as its title and author, are determined as a result of processing the digital image(s), the information may be matched against the database to obtain additional available information about the book stored in the database.

In other embodiments, instead of or in addition to maintaining its own database, the system may access other book databases, such as publishers' databases or online bookstores' databases, via a network such as the Internet to obtain information on the books. In this case, once some pieces of information about a book are determined, the information may be matched against the appropriate database(s) to obtain additional available information about the book stored in the database(s).

Sometimes, the system may find multiple matches in the database(s) for a particular book. Other times, there may not be sufficient information in the digital image(s) (steps 100 and 105) or in the data entered by the person directly (step 110) to determine a match for a particular book, perhaps due to the fact that a portion of the outside of the book is obscured in the digital image(s) (step 100 and 105) or that the person has entered some wrong information by mistake or has entered insufficient information (step 110). Therefore, at 130, the system may optionally show the person the automatically determined standard information about the books so that the person has a chance to confirm and/or correct any piece of information if necessary.

For example, if the system has found multiple matches for a particular book, then the person may be asked to choose or confirm the correct match from several possibilities. On the other hand, if no match is found for a particular book due to insufficient information in the digital image(s), then the person may be asked to input the relevant standard information (e.g., title, author, publisher, etc.) manually.

Sometimes, in addition to the standard information about the books, the person may wish to provide additional customized information, perhaps based on the person's personal opinions about the books. At 140, the system may optionally receive additional customized information about the books from the person. For example, a rating system may be provided that enables the person to rate individual books in the collection. The books may be rated using a numerical, star, or category system. In addition, the system may enable the person to provide personal comments and/or reviews and/or add tags on individual books. The ratings, tags, and/or comments may be stored in the person's account or profile on the system along with the books.

At 150, the customized information provided by the person on his or her collection of books is aggregated with existing customized information stored in the system that has been provided by other people who have also registered with the system and uploaded their respective collections of books. In one or more embodiments, statistical information about individual books may be determined based on information collected from all customers whose respective collections of books include those individual books. For example, for each particular book, an aggregated rating for that book may be an average of all the ratings submitted from all the customers who have rated that book. And, for each book, all the reviews and/or comments from all the people who have reviewed that book may be available. In one or more embodiments, the system provides a centralized location where anyone may access the ratings and reviews about any book existing in the system.

In one or more embodiments, the books in the system may be divided into categories based on various types of criteria, such as subject matter, literary form, publication data, language, author, tag, author group (e.g., similarly rated authors for a category), library categories, etc. The categories may exist on multiple levels. For example, in one system of categorization, on the top level, the books may be divided into fiction and non-fiction. Then, within the fiction category, there may be romance, mystery, science fiction, fantasy, adventure, etc. And within non-fiction, there may be biography, history, travel, etc.

The books may also be divided into alternative categories based on the demographic information of the people associated with the books, such as people's geographical location, age, gender, education level, profession, income, interests, etc. For example, the books may be segmented based on age groups, first dividing books into children books and adult books, and then within the children books group further dividing the books into young children books and teenager books and within the adult books group further dividing the book into young adult books, books for middle-aged adults, books for seniors, and so on. Within each category, the books are generally enjoyed by people of the corresponding age group.

Thus, a particular book may belong to multiple categories simultaneously depending on the specific methods used by the system to categorize the books. For example, a book may belong to both adventure and romance categories if both subject matters are covered in the book. Or a book may belong to both science fiction and adult categories.

In other embodiments, the books may be associated with profiles that represent demographic segments of the people who have read the books and/or the readers' ratings and reviews of the books, and/or profiles that represent the contexts of the books, which may be independent of the demographic segments of the readers, such as subject matters, literary forms, publication data, languages, authors, tags, author groups (i.e., similarly rated authors for a category), library categories, etc.

At 160, the system may recommend books to a person based on the person's collection of books, and optionally further based on the books' ratings and/or reviews, the person's demographical information, the person's interest profile, and/or other collections of books in the system. By taking into consideration the person's collection of books instead of just a few books, the system may better tailor the recommendations to the person's particular interest.

For example, the system may consider the categories of the books in the person's collection. If there are mystery books as well as romance books in the person's collection, the system may recommend books that have received high customer ratings and/or good reviews as well as cover both mystery and romance themes. Or, if there are many travel books in the person's collection, the system may recommend books on different cultures or countries.

The system may consider the ratings and/or reviews submitted by the person himself or herself. For example, if a person has given good ratings and/or reviews to the works of a particular author, the person may enjoy other works by the same author or similar authors, and the system may recommend additional works by the same author or similar authors that have received good ratings and/or reviews from other people as well. Or, if the person has given good ratings to several books with a common theme (e.g. stories about international travel), this may be an indication that the person enjoys books of this particular theme. This may enable the system to create, maintain, or update an interest profile for the person that contains the person's interest categories. In other words, the interest profile for each person may indicate the types of books (e.g., categories, themes, etc.) the person enjoys. The interest profile for each person may be stored in the system. The system may then recommend other books covering the same or similar themes based on the interest profile.

If two or more people have similar interests and/or demographic profile, the system may recommend books from one or more people's collection to another person. For example, if person A and person B, have both given high ratings to some number of the same books, the system may recommend one or more books from person A's collection that are not in person B's collection to person B.

Optionally, the system may consider additional, perhaps personal, information about a person, if such information is available, when tailoring book recommendations to each individual. In one or more embodiments, when a person registers with the system, the system may ask the person to optionally provide certain pieces of personal information, such as the person's age, gender, geographical location, education level, profession, income bracket, marital status, interests, hobbies, etc. (i.e., demographical information). If the person chooses to provide such demographical information, the information may be stored in a database accessible by the system. In addition, some of the information, such as age, gender, interests, and profession may also be inferred by the books in the collection associated with the person, and geographic location may be inferred by the person's computer's IP address. The demographical information for each person may be used to construct a demographical profile for the person, and the profile may be stored in the system.

The demographical information may also be taken into consideration, in addition to the information about the person's collection of books, when the system makes book recommendations to the person. For example, statistically speaking, a person's literary taste or interest may be influenced by his or her age, gender, education level, geographical location, etc. People in their teens or twenties may enjoy different types of books than people in their sixties or seventies. People working in different industries may enjoy books particularly related to their respective fields of profession (e.g. science and engineering, business, psychology, finance, etc.). The system may further tailor book recommendations to specific individuals based on these types of personal information. In another example, if person A searches for a book in a new interest category, then the system may recommend one or more books that are highly rated by one or more people that have similar demographic and/or interest profiles as person A and also have an interest in person A's new interest category.

At 170, the system may facilitate discussions about the books. In one or more embodiments, the system may provide an online forum for this purpose. Through such an online forum, a person may be able to find other people who like the same types of books the person enjoys. For example, if a person likes a particular book, he or she may read reviews submitted by other people with respect to this book. If he or she finds another person who has also given a good review on this book, he or she may wish to contact this other person to discuss the book, since both of them apparently enjoy the same book. The system may recommend to a person possible candidates with whom the person may like to have discussions based on people's interest and/or demographical profiles.

The online forum may be open only to registered account holders or may be open to anyone (i.e., both registered account holders and people who have not yet registered). People may chat with each other, post messages, reply messages, send emails or instant message to individuals or groups of people, and etc. via their computers, mobile telephones, or wireless devices such as PDAs (personal data assistant). The discussion may be focused on a single book, on multiple books, on a whole category of books, an author, a publisher, etc.

There are many ways for the system to facilitate social interactions among the readers. For example, the system may create various chat rooms, each chat room having a particular discussion topic. The topics may be general or specific. One chat room may be devoted to poetry, while another chat room may be devoted to 19th century French literature. A person may join whichever chat room he or she desires to find other people having similar interest. Similarly, various email groups or message groups may be created, each group targeting a particular topic. People may join whichever group they find interesting. Discussions may be done via emails, via messages sent to people within the group, or via postings on a web site.

As will be understood, 100, 105, 110, 120, 130, 140, 150, 160, and 170 may be implemented as one or more software programs. For example, people may download the digital image(s) of their book collections onto their computers and upload them into the system using web browsers. Similarly, people may register with the system and log onto the system via web browsers or client applications. A user interface may be designed and implemented so that people may enter book information into the system directly. Again, such user interface may be accessed through web browsers or client applications.

There are many commercially available OCR software programs available that may be used to parse the digital image(s) to obtain book information (e.g., title, author, publisher, etc.). Alternatively, a new OCR software program may be designed and implemented for the system.

One or more databases may be used to store information about books and people. The system may manage these databases (e.g. to add, modify, or retrieve the information) using the Structured Query Language (SQL).

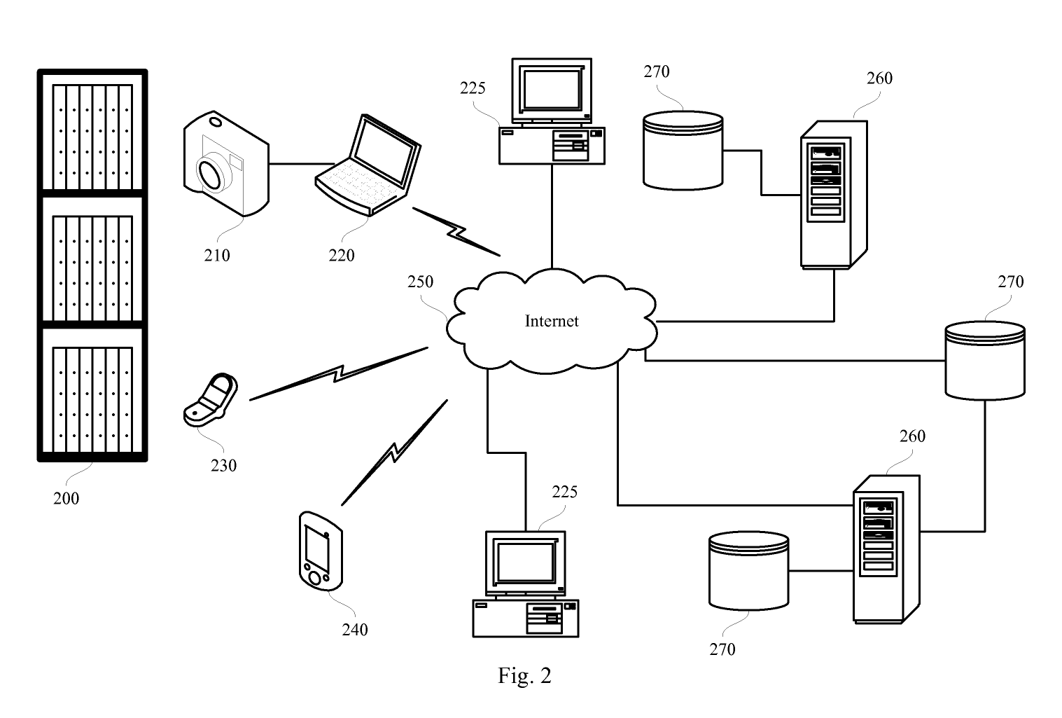

The method described above in FIG. 1 may be carried out, for example, in a programmed computing system. FIG. 2 is a simplified diagram of a network environment in which specific embodiments of the present invention may be implemented. A collection of books may be stored on a bookshelf 200. Image(s) of the bookshelf 200 may be taken using a digital camera 210 or a mobile telephone 230 camera. The image data may be uploaded to the system either directly from the camera 210 or the mobile telephone 230 or through a computer 220 connected to the system via the Internet 250.

The various aspects of the invention may be practiced in a wide variety of network environments (represented by Internet 250) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. The software program implementing various embodiments of the system may be executed on the one or more servers 260.

According to various embodiments, information relating to collections of books (e.g. titles, authors, publishers, ISBNs, customer ratings, reviews, etc.) as well as personal information about people who have registered with the system may be stored in one or more databases 270. Similarly, additional information about published books, which may be obtained from the publishers, may also be stored in one or more databases 270. And the databases 270 may be communicatively linked with the servers 260 so that the system may have access to data stored in the databases 270.

People may access the system using different methods, such as from computers 220, 225, mobile telephones 230, or PDAs 240 connected to the system via the Internet 250. People may receive book recommendations as well as having discussions with other people using their computers 220, 225, mobile telephones 230, or PDAs 240. People may also receive book recommendations and/or notifications on recently published books that are recommended by the system to the user.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method for recommending books, comprising:
receiving data representing at least one image of a collection of books;
automatically determining at least one piece of standard information about the collection of books by processing the image data; and
recommending at least one book that is not included in the collection of books to a person associated with the collection of books based on the collection of books.

2. The computer-implemented method, as recited in claim 1, wherein the collection of books is a first collection of books and the recommending at least one book is further based on at least one additional collection of books other than the first collection of books.

3. The computer-implemented method, as recited in claim 1, wherein the recommending at least one book is further based on at least one piece of personal information about the person associated with the collection of books.

4. The computer-implemented method, as recited in claim 3, wherein the personal information about the person is at least one selected from the group consisting of age, gender, geographical location, profession, education, income, and interests.

5. The computer-implemented method, as recited in claim 1, further comprising:
retrieving at least one additional piece of standard information about the collection of books from a database based on the automatically determined at least one piece of standard information about the collection of books.

6. The computer-implemented method, as recited in claim 5, wherein the standard information about the collection of books is at least one selected from the group consisting of title, author, publisher, publication date, edition, binding, and ISBN.

7. The computer-implemented method, as recited in claim 1, further comprising:
receiving at least one confirmation on the automatically determined at least one piece of standard information about the collection of books; and
receiving at least one correction on the automatically determined at least one piece of standard information about the collection of books.

8. The computer-implemented method, as recited in claim 1, further comprising:
receiving at least one rating for at least one book from the collection of books, wherein each rating is associated with each book respectively; and
for each book for which a rating is received,
aggregating the rating with existing ratings for the book,
storing the standard information, the ratings, and the aggregated rating for the book, and
publishing the aggregated rating.

9. The computer-implemented method, as recited in claim 8, wherein the aggregating the rating with existing ratings for the book comprises averaging the rating and the existing ratings for the book to obtain an aggregated rating for the book.

10. The computer-implemented method, as recited in claim 1, further comprising:
receiving at least one review for at least one book from the collection of books, wherein each review is associated with each book respectively; and
for each book for which a review is received,
aggregating the review with existing reviews for the book,
storing the standard information and the reviews for the book; and
publishing the reviews.

11. The computer-implemented method, as recited in claim 1, further comprising:
facilitating discussions on at least one book from the collection of books.

12. A computer program product for recommending books, comprising a computer-readable medium having a plurality of computer program instructions stored therein, which are operable to cause at least one computing device to:
receive data representing at least one image of a collection of books;
automatically determine at least one piece of standard information about the collection of books by processing the image data; and
recommend at least one book that is not included in the collection of books to a person associated with the collection of books based on the collection of books.

13. The computer program product, as recited in claim 12, wherein the collection of books is a first collection of books and the recommend at least one book is further based on at least one additional collection of books other than the first collection of books.

14. The computer program product, as recited in claim 12, wherein the recommend at least one book is further based on at least one piece of personal information about the person associated with the collection of books.

15. The computer program product, as recited in claim 14, wherein the personal information about the person is at least one selected from the group consisting of age, gender, geographical location, profession, education, income, and interests.

16. The computer program product, as recited in claim 12, wherein the computer program instructions are further operable to cause the at least one computing device to:
retrieve at least one additional piece of standard information about the collection of books from a database based on the automatically determined at least one piece of standard information about the collection of books.

17. The computer program product, as recited in claim 16, wherein the standard information about the collection of books is at least one selected from the group consisting of title, author, publisher, publication date, edition, binding, and ISBN.

18. The computer program product, as recited in claim 12, wherein the computer program instructions are further operable to cause the at least one computing device to:
receive at least one confirmation on the automatically determined at least one piece of standard information about the collection of books; and
receive at least one correction on the automatically determined at least one piece of standard information about the collection of books.

19. The computer program product, as recited in claim 12, wherein the computer program instructions are further operable to cause the at least one computing device to:
receive at least one rating for at least one book from the collection of books, wherein each rating is associated with each book respectively; and
for each book for which a rating is received,
aggregate the rating with existing ratings for the book,
store the standard information, the ratings, and the aggregated rating for the book, and
publish the aggregated rating.

20. The computer program product, as recited in claim 19, wherein the aggregate the rating with existing ratings for the book comprises computer program instructions that are operable to cause the at least one computing device to average the rating and the existing ratings for the book to obtain an aggregated rating for the book.

21. The computer program product, as recited in claim 12, wherein the computer program instructions are further operable to cause the at least one computing device to:
receive at least one review for at least one book from the collection of books, wherein each review is associated with each book respectively; and
for each book for which a review is received,
aggregate the review with existing reviews for the book,
store the standard information and the reviews for the book; and
publish the reviews.

22. The computer program product, as recited in claim 12, wherein the computer program instructions are further operable to cause the at least one computing device to:
facilitate discussions on at least one book from the collection of books.
